(19) United States
(12) Patent Application Publication
(10) Pub. No.: US 2019/0377360 A1
(43) Pub. Date: Dec. 12, 2019

(54) METHOD FOR ITEM DELIVERY USING AUTONOMOUS DRIVING VEHICLE

(71) Applicant: LG ELECTRONICS INC., Seoul (KR)

(72) Inventors: Jarang KIM, Seoul (KR); Yuna SEO, Seoul (KR)

(73) Assignee: LG ELECTRONICS INC., Seoul (KR)

(21) Appl. No.: 16/548,747

(22) Filed: Aug. 22, 2019

(30) Foreign Application Priority Data
Jun. 19, 2019 (KR) 10-2019-0073095

(51) Int. Cl. G05D 1/02; G08G 1/127; H04W 4/44; G06Q 10/08

(52) U.S. Cl. CPC G05D 1/0276; G06Q 10/08; H04W 4/44; G08G 1/127

(57) ABSTRACT

There is provided a method of delivering an item using an autonomous driving vehicle, including: receiving, from a server, a driving request signal for an item delivery service and controlling a vehicle to reach a location of a first terminal; providing a user of the first terminal with an item storage space, in a case where an authentication completion signal for the user of the first terminal is received from the server after the vehicle reaches the location of the first terminal; controlling the vehicle to reach the location of the second terminal, in a case where storage of the item is completed; and providing a user of the second terminal with the item, in a case where an authentication completion signal for the user of the second terminal is received from the server after the vehicle reaches the location of the second terminal.

### CROSS-REFERENCE TO RELATED APPLICATION

Pursuant to 35 U.S.C. § 119(a), this application claims the benefit of earlier filing date and right of priority to Korean Patent Application No(s). 10-2019-0073095, filed on Jun. 19, 2019, the contents of which are hereby incorporated by reference herein in its entirety.

### BACKGROUND

### 1. Field

The present disclosure relates to a method of delivering an item using an autonomous driving vehicle.

### 2. Description of the Related Art

An autonomous driving vehicle refers to a vehicle on which an autonomous driving apparatus capable of recognizing an environment around the vehicle and a vehicle state, and thus controlling the driving of the vehicle is mounted. As researches on an autonomous driving vehicle are carried out, researches on various services that may increase the convenience of a user using autonomous driving vehicles are being carried out together.

Meanwhile, although the service of delivering an item using the autonomous driving vehicle may increase the convenience of the user, there is a problem that it is not possible to check a state of the item because there is no manager in the vehicle.

### SUMMARY

The disclosed embodiments disclose a method of providing an item delivery service using an autonomous driving vehicle and an autonomous driving apparatus therefor. A technical problem to be dealt with by the present embodiment is not limited to the aforementioned technical problems, and other technical problems may be inferred from the following embodiments.

According to an embodiment of the present invention, there is provided a method of delivering an item using an autonomous driving vehicle, including: receiving, from a server, a driving request signal including a location of a first terminal and a location of a second terminal and controlling a vehicle to reach the location of the first terminal; providing a user of the first terminal with an item storage space, in a case where an authentication completion signal for the user of the first terminal is received from the server after the vehicle reaches the location of the first terminal; controlling the vehicle to reach the location of the second terminal, in a case where storage of the item is completed; and providing a user of the second terminal with the item, in a case where an authentication completion signal for the user of the second terminal is received from the server after the vehicle reaches the location of the second terminal.

According to another embodiment of the present invention, there is provided An autonomous driving apparatus including: a processor configured to receive, from a server, a driving request signal including a location of a first terminal and a location of a second terminal and to control a vehicle to reach the location of the first terminal, to provide a user of the first terminal with an item storage space, in a case where an authentication completion signal for the user of the first terminal is received from the server after the vehicle reaches the location of the first terminal, to control the vehicle to reach the location of the second terminal, in a case where storage of the item is completed, and to provide a user of the second terminal with the item, in a case where an authentication completion signal for the user of the second terminal is received from the server after the vehicle reaches the location of the second terminal; a communication unit configured to transmit data to or receive data from the server; and a memory configured to store the driving request signal.

According to still another embodiment of the present invention, there is provided a method of delivering an item using an autonomous driving vehicle, including: receiving, from a first terminal, a request for an item delivery service using the autonomous driving vehicle; transmitting information of a location of the first terminal to an autonomous driving apparatus, based on the request for the item delivery service; performing authentication for a user of the first terminal using authentication information received from the first terminal, in a case where it is determined that the autonomous driving vehicle reaches the location of the first terminal based on location information of the autonomous driving vehicle; performing control of the autonomous driving apparatus, to allow the user of the first terminal to store the item in the autonomous driving vehicle, in a case where the authentication for the user of the first terminal is completed; transmitting information of a location of a second terminal to the autonomous driving apparatus after the user of the first terminal stores the item; performing authentication for a user of the second terminal using authentication information received from the second terminal, in a case where it is determined that the autonomous driving vehicle reaches the location of the second terminal based on location information of the autonomous driving vehicle; and receiving information as to whether or not the user of the second terminal accepts the item, from at least one of the second terminal and the autonomous driving apparatus.

The specific matters of other embodiments are included in the detailed description and drawings.

According to an embodiment of the present invention, there is one or more of the following effects.

Firstly, there is an effect that, since an item is delivered using an autonomous driving vehicle, it is possible to provide an item delivery service without being limited by the location and time of a user.

Secondly, since a state of the item is continuously monitored through a sensor of the autonomous driving vehicle, it is possible to cope with a case where the item are broken or stolen.

Thirdly, there is another effect that, in a case where a user who has received the item does not accept the item, the user may return the item to another user who has delivered the item, thereby increasing the convenience of the users.

Fourthly, there is still another effect that, since a suitable vehicle is selected and utilized from among a plurality of autonomous driving vehicles based on item information, it is possible to effectively utilize the autonomous driving vehicles.

The effects of the invention are not limited to the aforementioned effects, and other effects that have not been mentioned may be apparently understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device 100 according to an embodiment of the present disclosure.

FIG. 2 illustrates AI server 200 according to an embodiment of the present disclosure.

FIG. 3 illustrates an AI system 1 according to an embodiment of the present disclosure.

FIGS. 4A and 4B are views illustrating an example of delivering an item using an autonomous driving vehicle according to an embodiment of the present invention.

FIG. 5 is a view illustrating an example in which the autonomous driving vehicle monitors a user and an item of a second terminal according to another embodiment of the present invention.

FIG. 6 is a view illustrating an example in which an autonomous driving vehicle and a server according to an embodiment of the present invention determine that an abnormal manifestation has occurred in an item and a user of the second terminal.

FIG. 7 is a view illustrating a screen of a first terminal according to another embodiment of the present invention.

FIG. 8 is a view illustrating a screen of a second terminal according to another embodiment of the present invention.

FIG. 9 is a block diagram of an autonomous driving apparatus according to an embodiment of the present invention.

FIG. 10 a diagram illustrating an example of a method of delivering an item using an autonomous driving vehicle according to an embodiment of the present invention.

FIG. 11 is a flowchart of a method of delivering an item using an autonomous driving vehicle, which is performed by the autonomous driving vehicle according to an embodiment of the present invention.

FIG. 12 is a flowchart of a method of monitoring an item and a user of a second terminal, which is performed by the autonomous driving apparatus according to another embodiment of the present invention.

FIG. 13 is a flowchart of a method of delivering an item using an autonomous driving vehicle, which is performed by a server according to an embodiment of the present invention.

FIG. 14 is a flowchart of a method of delivering an item using an autonomous driving vehicle, which is performed by a server according to another embodiment of the present invention.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Exemplary embodiments of the present invention are described in detail with reference to the accompanying drawings. Detailed descriptions of technical specifications well-known in the art and unrelated directly to the present invention may be omitted to avoid obscuring the subject matter of the present invention. This aims to omit unnecessary description so as to make clear the subject matter of the present invention. For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification. It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams. Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions. According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

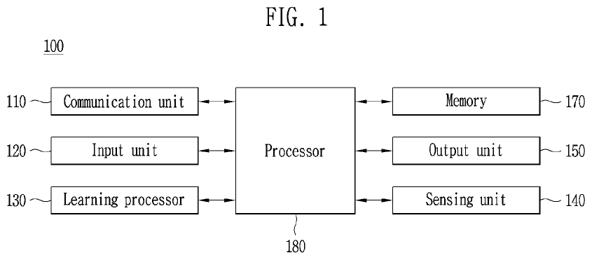

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

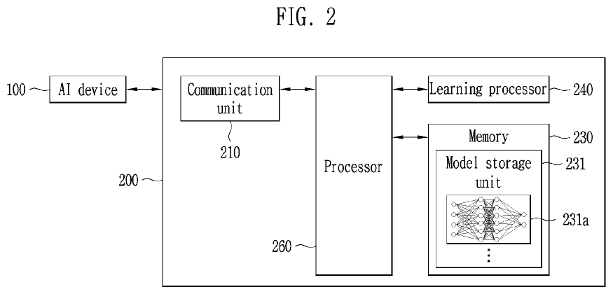

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

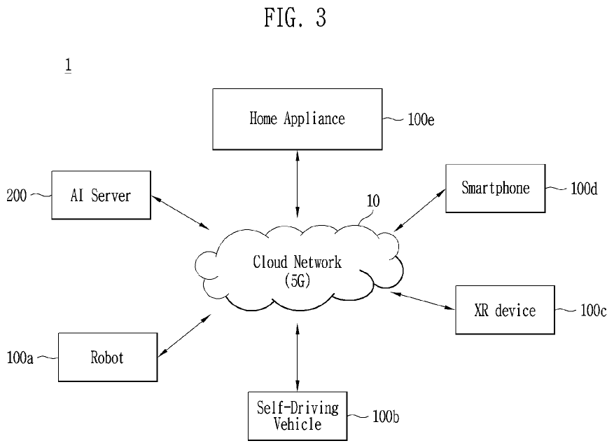

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

An autonomous driving vehicle according to the present invention moves to a location of a first terminal based on information received from a server and stores an item, and moves to a location of a second terminal and provides the stored item to the other user of a second terminal.

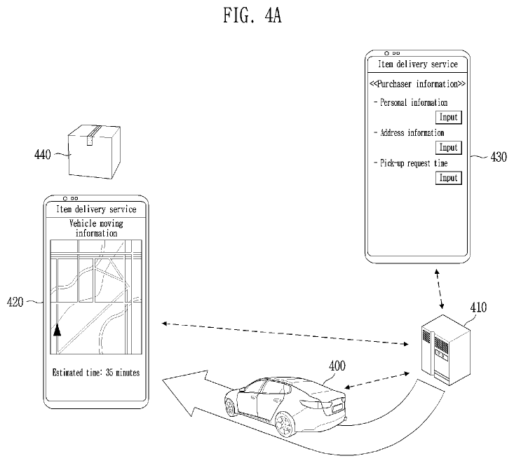

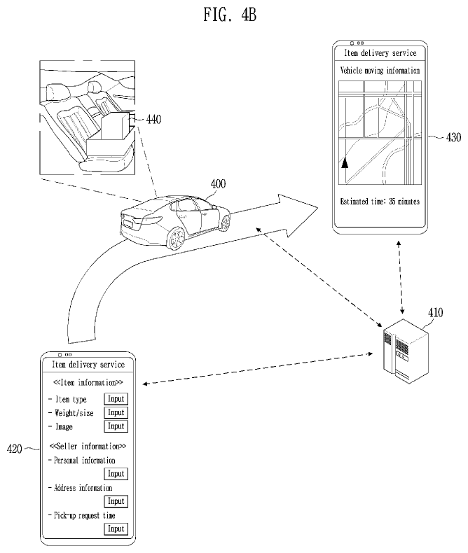

FIGS. 4A and 4B are views illustrating an example of delivering an item using an autonomous driving vehicle according to an embodiment of the present invention.

With reference to FIG. 4A, a first terminal 420 may make a request for an item delivery service to a server 410. In addition, after receiving the request, the server 410 may transmit location information of the first terminal 420 to the autonomous driving vehicle 400, so that the autonomous driving vehicle reaches a user of the first terminal 420 to which the item 440 is intended to be delivered. Upon receiving the location information of the first terminal 420, the autonomous driving vehicle 400 may move to the location of the first terminal 420.

Meanwhile, the request for the item delivery service, which has been transmitted by the first terminal 420 to the server 410, includes information on the item 440, user information of the first terminal 420, and information on a pickup location and time of the item 440, and the like, which the user of the first terminal 420 intends to deliver to the other user of the second terminal 430. However, the information included in the request for the item delivery service is not limited thereto.

In a case where the autonomous driving vehicle 400 reaches the location of the first terminal 420, an authentication procedure for the user of the first terminal 420 may proceed. For example, in a case where, after the autonomous driving vehicle 400 captures an image of the user of the first terminal 420 through a camera mounted on the autonomous driving vehicle 400, the autonomous driving vehicle 400 transmits the captured image to the server 410, the server 410 may compare the captured image with an image of the user of the first terminal 420 stored in advance and check whether the user of the first terminal 420 is correct. In addition, the user of the first terminal 420 may input the information of the autonomous driving vehicle 400 to the first terminal 420, so that the authentication procedure may be performed. However, a method of authenticating a user of the first terminal 420 is not limited thereto.

In a case where the authentication for the user of the first terminal 420 is completed, the server 410 may control the autonomous driving apparatus to allow the user of the first terminal 420 to load the item 440 in the autonomous driving vehicle 400. For example, the server 410 may open a door of the autonomous driving vehicle 400 or release a housing on which the item 440 may be loaded, to the outside of the autonomous driving vehicle 400. Here, the housing may be selected as a housing suitable for storing the item 440, based on the information on the item 440 included in the request for the item delivery service. In addition, it is obvious to those skilled in the art that the autonomous driving vehicle used for an item delivery service may be determined based on the information on the item 440.

FIG. 4B is a view illustrating an example in which the item 440 is moved to a location of the second terminal 430 after the item 440 is stored in the autonomous driving vehicle 400. The autonomous driving vehicle 400 transmits real-time location information to the server 410 during driving so that the server 410 may transmit the real-time location information of the autonomous driving vehicle 400 to the first terminal 420 and the second terminal 430.

In a case where the autonomous driving vehicle 400 reaches the location of the second terminal 430, an authentication procedure for the user of the second terminal 430 is performed, similarly to the authentication procedure for the user of the first terminal 420. In a case where the authentication for the user of the second terminal 430 is completed, the autonomous driving vehicle 400 may provide the item 440 to the user of the second terminal 430. Then, the server 410 may receive information as to whether or not the item 440 is accepted from the second terminal 430 and the autonomous driving vehicle 400.

Meanwhile, in the method of delivering the item according to the embodiment of the present invention, the user of the first terminal 420 may be a seller of the item 440 and the other user of the second terminal 430 may be a purchaser of the item 440. In this case, in a case where the server 410 receives information indicating that the purchaser accepts the item, the server 410 may make a request for payment of the item to a terminal of the purchaser.

In addition, in the method of delivering the item according to another embodiment of the present invention, the user of the first terminal 420 may be a person who intends to deliver an item using a quick service, and the user of the second terminal 430 may be a person who intends to receive the item. In this case, a payment procedure for the item 440 will be skipped.

As above, there is an effect that, in the method of delivering the item according to an embodiment of the present invention, it is possible to securely deliver an item regardless of time and location even though the user of the first terminal 420 and the user of the second terminal 430 are individuals.

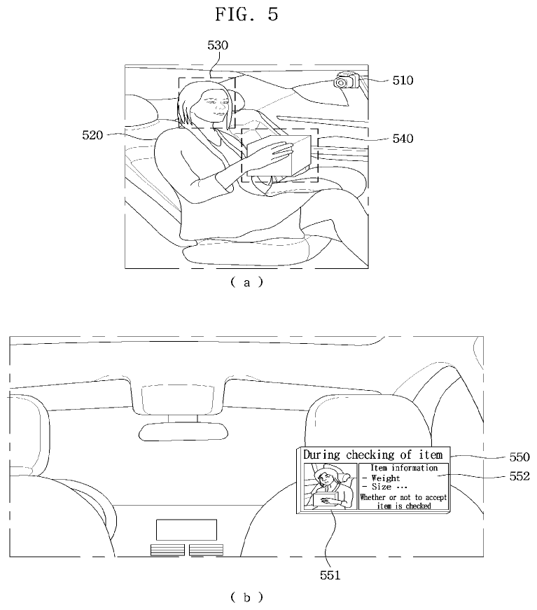

FIG. 5 is a view illustrating an example in which the autonomous driving vehicle monitors a user and an item of a second terminal according to another embodiment of the present invention.

While a user 520 of the second terminal checks an item 540, the autonomous driving apparatus according to the embodiment of the present invention may monitor the item 540 and the user 520 of the second terminal using a sensor mounted on the autonomous driving vehicle. FIG. 5 illustrates an embodiment in which monitoring is performed through a camera mounted on an autonomous driving vehicle, but the number of sensors used for monitoring and types of sensors are not limited thereto.

With reference to FIG. 5A, the user 520 of the second terminal may be on a rear seat of the autonomous driving vehicle in order to check the item 540. At this time, it is possible to monitor a face 530 of the user 520 of the second terminal, a location of the user 520 of the second terminal, a location of the item 540, and the like, through a camera 510 disposed on a front side of the rear seat. The autonomous driving vehicle may transmit monitored results to the server and the server may determine whether or not the item 540 is broken or stolen based on the monitored results. In addition, the autonomous driving vehicle may directly determine whether or not the item 540 is broken or stolen without transmitting the monitored results to the server.

Meanwhile, as illustrated in FIG. 5B, in a case where the user 520 of the second terminal is on the rear seat and checks the item 540, a display 550 disposed on the front side of the rear seat may display a current image 551 of the user 520 of the second terminal, and information 552 of the item. However, contents displayed on the display 550 are not limited thereto, and the display in which the current image 551 of the user 520 of the second terminal and the information 552 of the item are displayed are also not limited thereto. For example, the display 550 may further display user information of the first terminal and the like, as well as item information 552, and the current image 551 of the user 520 of the second terminal may be provided to the first terminal through the server 550.

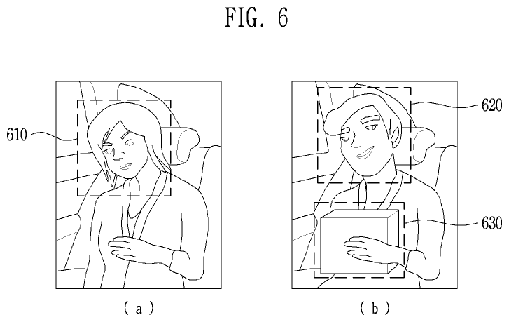

FIG. 6 is a view illustrating an example in which an autonomous driving vehicle and a server according to an embodiment of the present invention determine that an abnormal manifestation has occurred in an item and a user of the second terminal.

The autonomous driving apparatus and the server according to an embodiment of the present invention may determine an abnormal manifestation including whether or not the item is broken or stolen based on the monitored results of the item and the user of the second terminal.

For example, as illustrated in FIG. 6A, in a case where only a user 610 of the second terminal is checked, but a location of an item 630 is not checked, or in a case where the item 630 has an image different from an image of the item 630 stored in advance, the autonomous driving vehicle and the server may determine that the item 630 is broken or stolen, and the autonomous moving apparatus may output warning contents according to the determined results. The warning contents may be displayed on at least one of the first terminal, the second terminal, and a display visible to the user of the second terminal in the autonomous driving vehicle. In addition, the warning contents may be output in a form of a warning sound, and a format of the warning contents is not limited thereto.

Meanwhile, as illustrated in FIG. 6B, in a case where an image of a user 620 of the second terminal captured by the camera of the autonomous driving vehicle is different from an image of the user of the second terminal stored in advance in the server, the autonomous driving apparatus may output warning contents.

Further, in a case where it is determined as monitored results that the item 630 is broken or stolen by the user 610 of the second terminal, the server may impose fines or additional penalties on the second terminal.

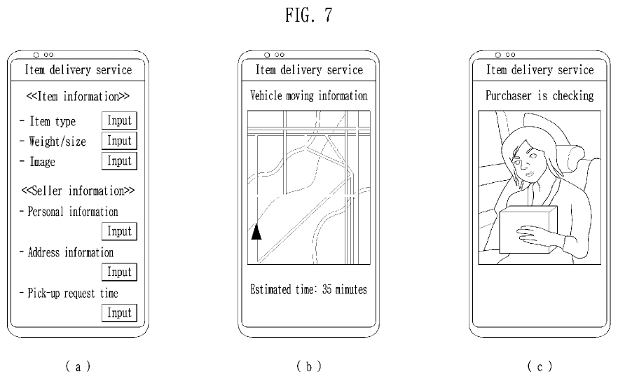

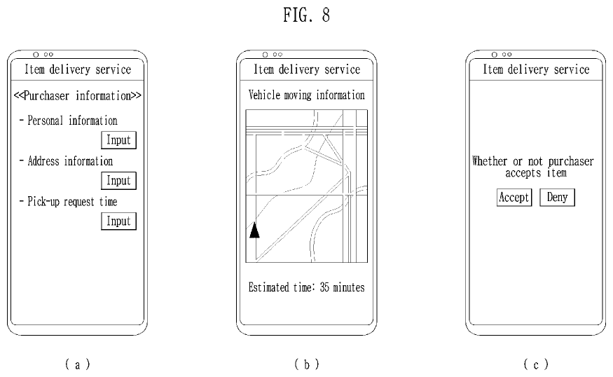

Thereafter, FIGS. 7 and 8 are views for explaining contents which may be respectively displayed in the first terminal and the second terminal, in a case where the user of the first terminal is a seller of the item and the user of the second terminal is a purchaser of the item. FIGS. 7 and 8 illustrate contents displayed on the first terminal and the second terminal in a course of delivering an item, on a premise that an item transaction procedure between a user of the first terminal and a user of the second terminal has already been completed. However, it is obvious to those skilled in the art that a method of delivering an item according to an embodiment of the present invention further may include performing the item transaction procedure between the user of the first terminal and the user of the second terminal.

FIG. 7 is a view illustrating a screen of a first terminal according to another embodiment of the present invention.

With reference to FIG. 7A, in a case where the user of the first terminal is the seller of the item, the user of the first terminal may input item information and his/her own information when making a request for the item delivery service. At this time, information on the item to be input may include information such as a type of the item, weight, size, and color of the item, and an image of the item may be uploaded. Meanwhile, seller information refers to user information of the first terminal, and may include personal information, account information, credit card information, address information for storing the item, and item pick-up request time. In addition, an image regarding the user of the first terminal may be uploaded, and the uploaded image may be used for the purpose of authenticating the user of the first terminal after the autonomous driving vehicle reaches the location of the first terminal. However, it is obvious to those skilled in the art that the item information and seller information is not limited thereto, and more information may be input by the user of the first terminal.

With reference to FIG. 7B, the user of the first terminal may receive real-time location information of the autonomous driving vehicle. Specifically, it is possible to receive real-time location information on a route on which the autonomous driving vehicle moves from a location of the first terminal to a location of the second terminal and a route on which the autonomous driving vehicle moves from the location of the second terminal to a storage location, as well as a route on which the autonomous driving vehicle reaches the location of the first terminal in order to store the item, and to display the information.

With reference to FIG. 7C, the user of the first terminal may receive, through the server, monitored results received from the autonomous driving apparatus when the user of the second terminal checks the item.

Meanwhile, in a case where the user of the second terminal does not accept the item, the first terminal may receive item return information from the user of the first terminal, and the item return information may include a return location and return time of the item, and the like.

In addition, the first terminal may receive, from the server, state information as to whether or not the item is broken or stolen, or the like, and display the state information.

FIG. 8 is a view illustrating a screen of a second terminal according to another embodiment of the present invention.

With reference to FIG. 8A, the user of the second terminal may input his/her own information. In FIG. 8A, purchaser information refers to user information of the second terminal, and may include personal information, account information, credit card information, address information for receiving an item, item pick-up request time, and the like. In addition, an image regarding the user of the second terminal may be uploaded, and the uploaded image may be used for the purpose of authenticating the user of the second terminal after the autonomous driving vehicle reaches the location of the second terminal.

With reference to FIG. 8B, the second terminal may receive a real-time location of the autonomous driving vehicle on which the item is loaded, from the server and display the real-time location, similarly to the first terminal.

In addition, with reference to FIG. 8C, the second terminal may provide contents to allow the user of the second terminal to perform an input on whether or not the item received by the user of the second terminal is accepted

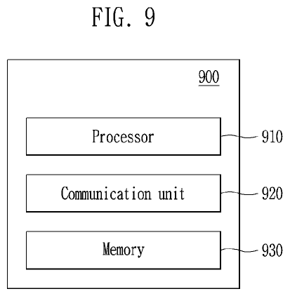

FIG. 9 is a block diagram of an autonomous driving apparatus according to an embodiment of the present invention.

An autonomous driving apparatus 900 according to an embodiment of the present invention may include a processor 910, a communication unit 920, and a memory 930.

The processor 910 may receive, from a server, a driving request signal including a location of a first terminal and a location of a second terminal and control a vehicle to reach the location of the first terminal, and in a case where an authentication completion signal for a user of the first terminal is received from the server after the vehicle reaches the location of the first terminal, the processor 910 may provide the user of the first terminal with an item storage space, to allow the user of the first terminal to store an item. Here, the vehicle refers to an autonomous driving vehicle on which an autonomous driving apparatus is mounted, and the driving request signal may be a signal generated when a request for the item delivery service is received from the first terminal to the server.

Thereafter, in a case where storage of the item is completed, the processor 910 may control the vehicle to reach the location of the second terminal, and in a case where an authentication completion signal for a user of the second terminal is received from the server after the vehicle reaches the location of the second terminal, the processor 910 may provide the user of the second terminal with the item, to allow the user of the second terminal to check the item.

In addition, the processor 910 may monitor at least one of the item and user of the second terminal using the sensor of the vehicle, in a case where the authentication completion signal for the user of the second terminal is received.

Then, the processor 910 may determine at least one of whether or not the item is broken, or whether or not the item is stolen based on the monitored results, and in a case where the item is broken or stolen, the processor 910 may output warning contents. Here, it is possible to determine at least one of whether or not the item is broken, or whether or not the item is stolen, by comparing at least one of appearance information on the item, size information, color information, and weight information received from the sensor of the vehicle, with information on the item stored in advance.

Meanwhile, in a case where return information of the item is received from the server, the processor 910 may control the vehicle to reach a return location included in the return information of the item.

Meanwhile, the communication unit 920 may transmit data to or receive data from the server, and the detailed features and functions of the communication unit 920 correspond to the communication unit 110 in FIG. 1. Therefore, detailed description thereof will not be repeated.

In addition, the memory 930 may store the driving request signal, and the detailed features and functions of the memory 930 correspond to the memory 170 in FIG. 1. Therefore, detailed description thereof will not be repeated.

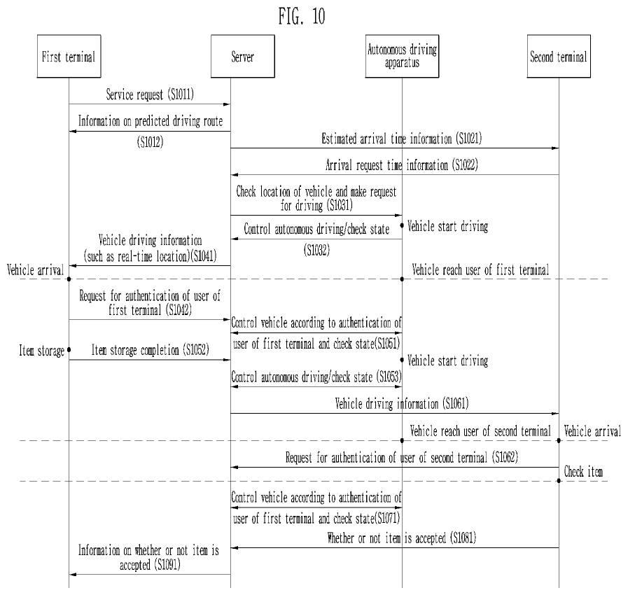

FIG. 10 is a diagram illustrating an example of a method of delivering an item using an autonomous driving vehicle according to an embodiment of the present invention.

In S1011, the first terminal transmits a request for the item delivery service to the server. At this time, the request for the item delivery service transmitted by the first terminal may include item information, the user information of the first terminal, the user information of the second terminal to receive the item, item pick-up time, and information of the location of the first terminal. For example, the item information may include a type of the item, a price and a size of the item, and cautions for handling the item, and the like, but the item information is not limited thereto.

In S1012, the server may transmit information on a predicted driving route to the first terminal. The server may provide the first terminal with an estimated time period during which the autonomous driving vehicle for delivering the item reaches the location of the first terminal, according to the item pickup time received from the first terminal and location information of the first terminal.

In addition, in step S1021, the server may calculate a time period during which the autonomous driving vehicle loads the item at the location of the first terminal and reaches the location of the second terminal, and may transmit, to the second terminal, estimated arrival time information of the autonomous driving vehicle. At this time, in a case where the server receives a plurality of item pickup request signals from the first terminal, the server may transmit, to the second terminal, a plurality of pieces of estimated arrival time information, accordingly. In a case where the second terminal has received a plurality of pieces of estimated arrival time information, the second terminal may transmit, to the server, arrival request time information on the item in step S1022.

In S1031, the server may check the location of the autonomous driving vehicle and make a request for driving to the autonomous driving apparatus.

Thereafter, the autonomous driving vehicle may start driving in order to reach the location of the first terminal, and in S1032, the autonomous driving apparatus may transmit real-time location information to the server, and the server may send, to the autonomous driving apparatus, a signal for additionally controlling the driving of the autonomous driving vehicle.

In S1041, the server may transmit vehicle driving information to the first terminal. Here, the vehicle driving information may include real-time location information of the autonomous driving vehicle. Accordingly, the user of the first terminal may check the location of the autonomous driving vehicle in real-time.

Meanwhile, after the autonomous driving vehicle reaches the location of the first terminal, the first terminal may make a request for authentication for the user of the first terminal to the server. In a case where the authentication for the user of the first terminal is completed, the server may control the autonomous driving apparatus to allow the user of the first terminal to store the item in S1051. At this time, based on the information on the item, the autonomous driving apparatus may search for cautions for storing the item, and the like, and then output the cautions to the first terminal or the autonomous driving vehicle. In addition, the autonomous driving apparatus may check a state of the item through an image of the stored item, color information, weight information, and the like, received from a sensor of the vehicle, and may send the checked state of the item to the server.

After the user of the first terminal stores the item in the autonomous driving vehicle, the first terminal may send an item storage completion signal to the server in S1052.

Thereafter, in S1053, the autonomous driving vehicle starts driving in order to reach the location of the second terminal, and the autonomous driving apparatus transmits real-time location information to the server, and the server transmits, to the autonomous driving apparatus, a signal for additionally controlling driving of the autonomous driving vehicle.

In S1061, the server may transmit vehicle driving information to the second terminal. Here, the vehicle driving information may include real-time location information of the autonomous driving vehicle. Accordingly, the user of the second terminal may check the location of the autonomous driving vehicle in real-time.

Meanwhile, after the autonomous driving vehicle reaches the location of the second terminal, in step S1062, the second terminal may make a request for authentication for the user of the second terminal to the server. In a case where the authentication for the user of the second terminal is completed, the server may control the autonomous driving apparatus to allow the item to be provided to the user of the second terminal in S1071. For example, in a case where the autonomous driving vehicle is a type of vehicle on which a person may ride, the user of the second terminal may ride on the autonomous driving vehicle to check the item. However, in a case where the autonomous driving vehicle is a type of vehicle on which a person may not ride, the user of the second terminal may check the item around the autonomous driving vehicle.

In step S1071, the autonomous driving apparatus may monitor the item and the user of the second terminal through the sensor mounted on the autonomous driving vehicle. The autonomous driving apparatus may transmit monitored results to the server to allow the server to determine whether the item is broken or stolen, and may determine whether the item is broken or stolen based on the monitored results. It is determined whether or not the item is broken, by comparing a result of monitoring the item while the user of the second terminal checks the item inside or around the autonomous driving vehicle, with item information input from the user of the first terminal or item information acquired upon storage of the item at the location of the first terminal.

In step S1081, the second terminal may transmit, to the server, information as to whether or not the user of the second terminal accepts the item. Then, in S1091, the server may transmit, to the first terminal, information as to whether or not the item is accepted, received from the second terminal.

In a case where the user of the first terminal is the seller of the item and the user of the second terminal is the purchaser of the item, the server may make a request for payment of the item to the second terminal, in the case where the user of the second terminal accepts the item.

In addition, in a case where the user of the second terminal does not accept the item, the user of the second terminal may re-store the item in the item storage space of the autonomous driving vehicle. Then, the server receives item return information from the first terminal, and may transmit, to the autonomous driving apparatus, a return location included in the item return information. Thereafter, the autonomous driving vehicle may start driving in order to reach the return location of the item.

It is determined whether or not the item is broken or replaced, and the like, by comparing a state of the returned item with the state information acquired when the user of the first terminal stores the item. In a case where the returned item is broken, that fact may be transmitted to at least one of the server and the second terminal, and subsequently, a countermeasure may be determined.

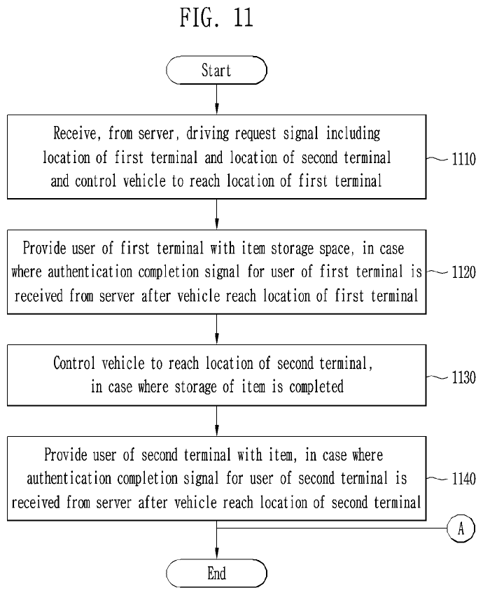

FIG. 11 is a flowchart of a method of delivering an item using an autonomous driving vehicle, which is performed by the autonomous driving vehicle according to an embodiment of the present invention.

In step 1110, the autonomous driving apparatus may receive, from a server, a driving request signal including a location of the first terminal and a location of the second terminal and control a vehicle to reach the location of the first terminal. Here, the vehicle refers to a vehicle on which an autonomous driving apparatus according to an embodiment of the present invention is mounted, and the driving request signal may be a signal generated when a request for the item delivery service is received from the first terminal to the server. Meanwhile, the request for the item delivery service may include at least one of the user information of the first terminal, the user information of the second terminal, information on the item, and information on item pickup request time. In addition, in a case where the information on the item is included in the request for the item delivery service, the vehicle and item auxiliary equipment mounted on the vehicle may be selected from a plurality of vehicles based on the information on the item.

In step 1120, in a case where the autonomous driving apparatus receives, from the server, the authentication completion signal for the user of the first terminal after the vehicle reaches the location of the first terminal, it is possible to provide the user of the first terminal with an item storage space. Here, the autonomous driving apparatus may acquire data on the user of the first terminal using the sensor mounted on the vehicle, and may perform an authentication procedure by comparing the acquired data with the user information of the first terminal stored in advance.

In step 1130, the autonomous driving apparatus may control the vehicle to reach the location of the second terminal, in a case where the storage of the item is completed. At this time, the autonomous driving apparatus may transmit real-time location information of the vehicle to the server.

In step 1140, in a case where the autonomous driving apparatus receives, from the server, an authentication completion signal for the user of the second terminal after the vehicle reaches the location of the second terminal, it is possible to provide the user of the second terminal with the item, to allow the user of the second terminal to check the item.

Meanwhile, the autonomous driving apparatus may monitor the item and the user of the second terminal after providing the user of the second terminal with the item.

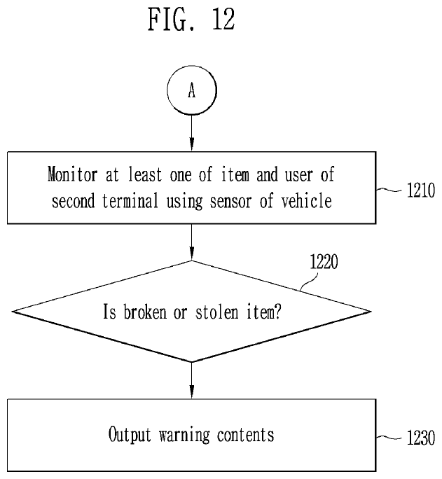

FIG. 12 is a flowchart of a method of monitoring an item and a user of a second terminal, which is performed by the autonomous driving apparatus according to another embodiment of the present invention.

In step 1210, in a case where the autonomous driving apparatus receives the authentication completion signal for the user of the second terminal, the autonomous driving apparatus may monitor at least one of the item and the user of the second terminal using the sensor of the vehicle. Here, the vehicle refers to an autonomous driving vehicle on which an autonomous driving apparatus is mounted.

In step 1220, based on the monitored results, the autonomous driving apparatus may determine at least one of whether or not the item is broken, or whether or not the item is stolen. Specifically, it is determined whether or not the item is broken, or whether or not the item is stolen, based on at least one of appearance information of the item, size information, color information, and weight information, received from the sensor of the vehicle.

In a case where the item is broken or stolen, in step 1230, the autonomous driving apparatus may output warning content. Here, warning contents may be output and displayed on a display located inside and outside the vehicle in a manner, and may be output in a form of a warning sound. However, a format of the warning contents is not limited thereto.

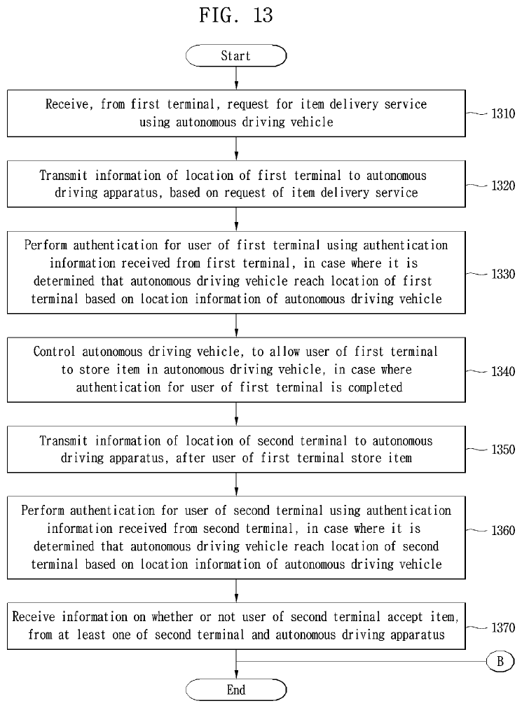

FIG. 13 is a flowchart of a method of delivering an item using an autonomous driving vehicle, which is performed by a server according to an embodiment of the present invention.

In step 1310, the server may receive, from the first terminal, a request for an item delivery service using the autonomous driving vehicle. Here, the request for the item delivery service may include at least one of the user information of the first terminal, the user information of the second terminal, information on the item, and information on item pickup request time.

In step 1320, the server may transmit information of the location of the first terminal to the autonomous driving apparatus, based on the request for the item delivery service. Here, the autonomous driving vehicle refers to a vehicle on which the autonomous driving vehicle is mounted, and the autonomous driving vehicle performs control of the autonomous driving vehicle.

In a case where it is determined in step 1330 that the autonomous driving vehicle reaches the location of the first terminal based on the location information of the autonomous driving vehicle, the server may perform authentication for the user of the first terminal using authentication information received from the first terminal.

In step 1340, in a case where the authentication for the user of the first terminal is completed, the server may control the autonomous driving vehicle, to allow the user of the first terminal to store the item in the autonomous driving vehicle.

In step 1350, after the user of the first terminal stores the item, the server may transmit information of the location of the second terminal to the autonomous driving apparatus.

In a case where it is determined in step 1360 that the autonomous driving vehicle reaches the location of the second terminal based on the location information of the autonomous driving vehicle, the server may perform authentication for the user of the second terminal using the authentication information received from the second terminal.

In step 1370, the server may receive information as to whether or not the user of the second terminal accepts the item, from at least one of the second terminal and the autonomous driving apparatus.

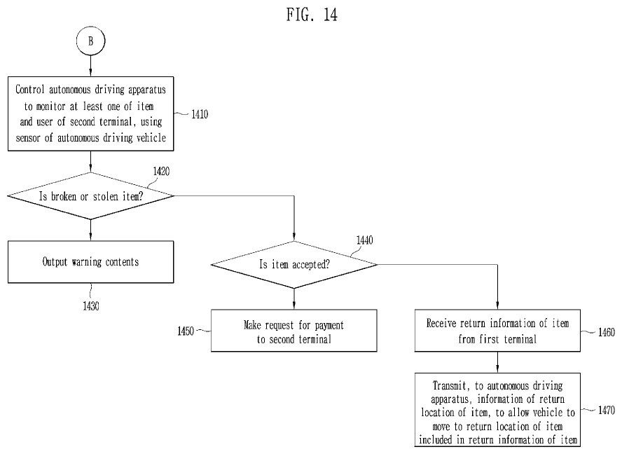

FIG. 14 is a flowchart of a method of delivering an item using an autonomous driving vehicle, which is performed by a server according to another embodiment of the present invention.

In step 1410, the server may control the autonomous driving apparatus to monitor at least one of the item and the user of the second terminal, using the sensor of the autonomous driving vehicle.

In step 1420, the server may determine whether the item is broken or stolen, based on the monitored results. Specifically, the server may determine whether or not the item is broken or stolen, by comparing at least one of appearance information of the item, size information, color information, and weight information received from the sensor of the autonomous driving vehicle, with information on the item stored in advance. In a case where it is determined that the item is broken or stolen, the server may perform step 1430, and otherwise, the server may perform step 1440.

In step 1430, the server may output warning contents to at least one of the first terminal, the second terminal, and the autonomous driving apparatus.

In step 1440, the server may receive information as to whether the user of the second terminal accepts the item from the second terminal. In a case where the user of the second terminal accepts the item, the server performs step 1450, and otherwise, the server may perform step 1460.

In step 1450, the server may make a request for payment of the item to the second terminal.

In step 1460, the server may receive return information of the item from the first terminal.

In step 1470, the server may transmit, to the autonomous driving apparatus, information of the return location of the item, to allow the vehicle to move to the return location of the item included in the return information of the item. In this case, the autonomous driving apparatus may control the autonomous driving vehicle to reach the return location of the received item.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of delivering an item using an autonomous driving vehicle, comprising:
receiving, from a server, a driving request signal including a location of a first terminal and a location of a second terminal and controlling a vehicle to reach the location of the first terminal, wherein the driving request signal is generated when a request for an item delivery service is received from the first terminal to the server;
providing a user of the first terminal with an item storage space, in a case where an authentication completion signal for the user of the first terminal is received from the server after the vehicle reaches the location of the first terminal;
controlling the vehicle to reach the location of the second terminal, in a case where storage of the item is completed; and
providing a user of the second terminal with the item, in a case where an authentication completion signal for the user of the second terminal is received from the server after the vehicle reaches the location of the second terminal.

2. The method of claim 1, further comprising: monitoring at least one of the item and user of the second terminal using a sensor of the vehicle, in the case where the authentication completion signal for the user of the second terminal is received.

3. The method of claim 2, further comprising:
determining at least one of whether or not the item is broken, or whether or not the item is stolen, based on the monitored results; and
outputting warning contents, in the case where the item is broken or stolen.

4. The method of claim 3, wherein determining at least one of whether or not the item is broken, or whether or not the item is stolen performs determination by comparing at least one of appearance information of the item, size information, color information, and weight information, received from a sensor of the vehicle, with information on the item stored in advance.

5. The method of claim 1, further comprising:
transmitting real-time location information of the vehicle to the server when the vehicle is driving.

6. The method of claim 1, further comprising: controlling the vehicle to reach a return location included in return information of the item, in the case where the return information of the item is received from the server.

7. The method of claim 1, wherein the request for the item delivery service received from the first terminal to the server includes at least one of user information of the first terminal, user information of the second terminal, information on the item, and information on item pickup request time.

8. The method of claim 7, wherein, in the case where the information on the item is included in the request for the item delivery service, the vehicle is selected from a plurality of vehicles based on the information on the item.

9. An autonomous driving apparatus comprising:
a processor configured to receive, from a server, a driving request signal including a location of a first terminal and a location of a second terminal and to control a vehicle to reach the location of the first terminal,
to provide a user of the first terminal with an item storage space, in a case where an authentication completion signal for the user of the first terminal is received from the server after the vehicle reaches the location of the first terminal,
to control the vehicle to reach the location of the second terminal, in a case where storage of the item is completed, and
to provide a user of the second terminal with the item, in a case where an authentication completion signal for the user of the second terminal is received from the server after the vehicle reaches the location of the second terminal, wherein the driving request signal is generated when a request for an item delivery service is received from the first terminal to the server;
a communication unit configured to transmit data to or receive data from the server; and
a memory configured to store the driving request signal.

10. The apparatus of claim 9, wherein the processor is configured to monitor at least one of the user of the second terminal and the item using the sensor of the vehicle when an authentication completion signal for the user of the second terminal is received.

11. The apparatus of claim 10, wherein the processor is configured to determine at least one of whether or not the item is broken, or whether or not the item is stolen based on the monitored results, and to output warning contents, in the case where the item is broken or stolen.

12. The apparatus of claim 11, wherein determining at least one of whether or not the item is broken, or whether or not the item is stolen performs determination by comparing at least one of appearance information of the item, size information, color information, and weight information, received from a sensor of the vehicle, with information on the item stored in advance.

13. The apparatus of claim 9, wherein the processor controls the vehicle to reach a return location included in return information of the item, in a case where the return information of the item is received from the server.

14. The apparatus of claim 9, wherein, in a case where information on the item is included in the request for the item delivery service received from the first terminal to the server, the vehicle is selected from a plurality of vehicles based on the information on the item.

15. A method of delivering an item using an autonomous driving vehicle, comprising:
receiving, from a first terminal, a request for an item delivery service using the autonomous driving vehicle;
transmitting information of a location of the first terminal to an autonomous driving apparatus, based on the request for the item delivery service;
performing authentication for a user of the first terminal using authentication information received from the first terminal, in a case where it is determined that the autonomous driving vehicle reaches the location of the first terminal based on location information of the autonomous driving vehicle;
performing control of the autonomous driving apparatus, to allow the user of the first terminal to store the item in the autonomous driving vehicle, in a case where the authentication for the user of the first terminal is completed;
transmitting information of a location of a second terminal to the autonomous driving apparatus after the user of the first terminal stores the item;
performing authentication for a user of the second terminal using authentication information received from the second terminal, in a case where it is determined that the autonomous driving vehicle reaches the location of the second terminal based on location information of the autonomous driving vehicle; and
receiving information as to whether or not the user of the second terminal accepts the item, from at least one of the second terminal and the autonomous driving apparatus.

16. The method of claim 15, further comprising:
controlling the autonomous driving apparatus to monitor at least one of the item and the user of the second terminal using the sensor of the autonomous driving vehicle, after authentication for a user of the second terminal is performed; and
receiving the monitored results.

17. The method of claim 16, further comprising:
determining at least one of whether or not the item is broken, or whether or not the item is stolen, based on the monitored results that are received; and
transmitting warning contents to at least one of the first terminal, the second terminal and the autonomous driving apparatus, in a case where it is determined that the item is broken or stolen.

18. The method of claim 15, further comprising:
receiving real-time location information of the autonomous driving vehicle from the autonomous driving apparatus; and
transmitting the received real-time location information of the autonomous driving vehicle to at least one of the first terminal and the second terminal.

19. The method of claim 15, further comprising:
making a request for payment of the item to the second terminal, when information indicating that the user of the second terminal accepts the item is received, in a case where the user of the first terminal is a seller of the item and the user of the second terminal is a purchaser of the item.

20. The method of claim 15, further comprising:
receiving return information of the item from the first terminal, in a case where information indicating that the user of the second terminal does not accept the item is received; and
transmitting, to the autonomous driving apparatus, information of the return location of the item, to allow the vehicle to move to the return location of the item included in the return information of the item.
